(19) United States
(12) Patent Application Publication
(10) Pub. No.: US 2013/0017811 A1
(43) Pub. Date: Jan. 17, 2013

(54) SIMULTANEOUS VOICE CALLS OF DISSIMILAR CLIENTS ON A SINGLE DEVICE

(71) Applicant: Soren LUNDSGAARD, Inverness, IL (US)

(72) Inventor: Soren LUNDSGAARD, Inverness, IL (US)

(73) Assignee: Motorola Solutions, Inc., Schaumburg, IL (US)

(21) Appl. No.: 13/183,620

(22) Filed: Jul. 15, 2011

(51) Int. Cl. H04W 4/00

(52) U.S. Cl. 455/416

(57) ABSTRACT

A mobile device includes a transceiver and a processor. The transceiver is configured to receive first wireless voice communications from a first end point in a first format. The processor is configured to reformat the first wireless voice communications from the first format to a second format. The second format is an operating format of a second end point. The transceiver transmits the reformatted first wireless voice communications to the second end point.

### BACKGROUND

An electronic device may be configured for voice applications. The voice application may connect a user from a first electronic device to another user of a second device (e.g., end point) to enable voice communications to be transmitted therebetween. The voice application may also be configured to provide additional features such as multi-party calls. In a multi-party call, the conventional electronic device is configured to connect to more than one end point and have voice communications to be transmitted thereamong. However, when connecting more than one end point, each end point is required to execute a common protocol of voice communication. Furthermore, the electronic device may be mobile which would have further requirements necessary for additional features of the voice applications to be performed. Conventionally, communication network components to which the mobile device may be connected are required to execute various functionalities for the voice application features to be performed on the mobile device.

Developments have been made to provide hardware to perform the additional features for voice applications. For example, a private branch exchange (PBX) is configured to handle different types of interfaces (i.e., voice communication protocols) but is restricted to non-mobile devices. Furthermore, the PBX is not an end device which a user utilizes. In addition, in a system utilizing the PBX, the end devices are wholly dependent on the intermediary disposed PBX system to provide every voice application feature. Even when various gateways are utilized, these are also intermediary disposed and simply provide a conversion of signals to adapt to the voice communication protocol. Further developments for multi-party calls are restricted to homogeneous interfaces, clients, protocols, etc.

### SUMMARY OF THE INVENTION

The present invention relates to a mobile device comprising a transceiver and a processor. The transceiver is configured to receive first wireless voice communications from a first end point in a first format. The processor is configured to reformat the first wireless voice communications from the first format to a second format. The second format is an operating format of a second end point. The transceiver transmits the reformatted first wireless voice communications to the second end point.

### DESCRIPTION OF THE DRAWINGS

FIG. 1 shows a multiple party voice call according to an exemplary embodiment of the present invention.

FIG. 2 shows a mobile unit configured to perform the multiple party voice call according to an exemplary embodiment of the present invention.

FIG. 3 shows a voice application for the multiple party voice call according to an exemplary embodiment of the present invention.

FIG. 4 shows a method for adding a further end point to a multiple party voice call according to an exemplary embodiment of the present invention.

FIG. 5 shows a method for terminating a further end point of a multiple party voice call according to an exemplary embodiment of the present invention.

### DETAILED DESCRIPTION

The exemplary embodiments may be further understood with reference to the following description and the appended drawings, wherein like elements are referred to with the same reference numerals. The exemplary embodiments of the present invention describe a multiple party voice call performed by a mobile unit (MU) that allows for end points having different interfaces to be included in the multi-party voice call. Specifically, the MU includes a voice application configured to perform a voice call already in progress with a first end point and subsequently add a second end point where the first end point and the second end point use different interfaces. The MU, the multi-party voice call, the end points, the interfaces, the voice application, and related methods will be discussed in further detail below.

It should be noted that the exemplary embodiments of the present invention relating to a voice call is only exemplary. The call described herein is referred to only as a voice call. However, the exemplary embodiments may further be adapted for voice and other forms of communication including video, data, any combination thereof, etc. Thus, the voice call used herein may generally refer to a voice call, a voice/video call, a voice/data call, a video call, a video/data call, a data call, a voice/video/data call, etc. It should also be noted that the exemplary embodiments of the present invention refer to clients of the end points as interfaces. However, the clients, interfaces, etc. of the end points may generally be known as a format in which the voice communications are received/transmitted by the end points.

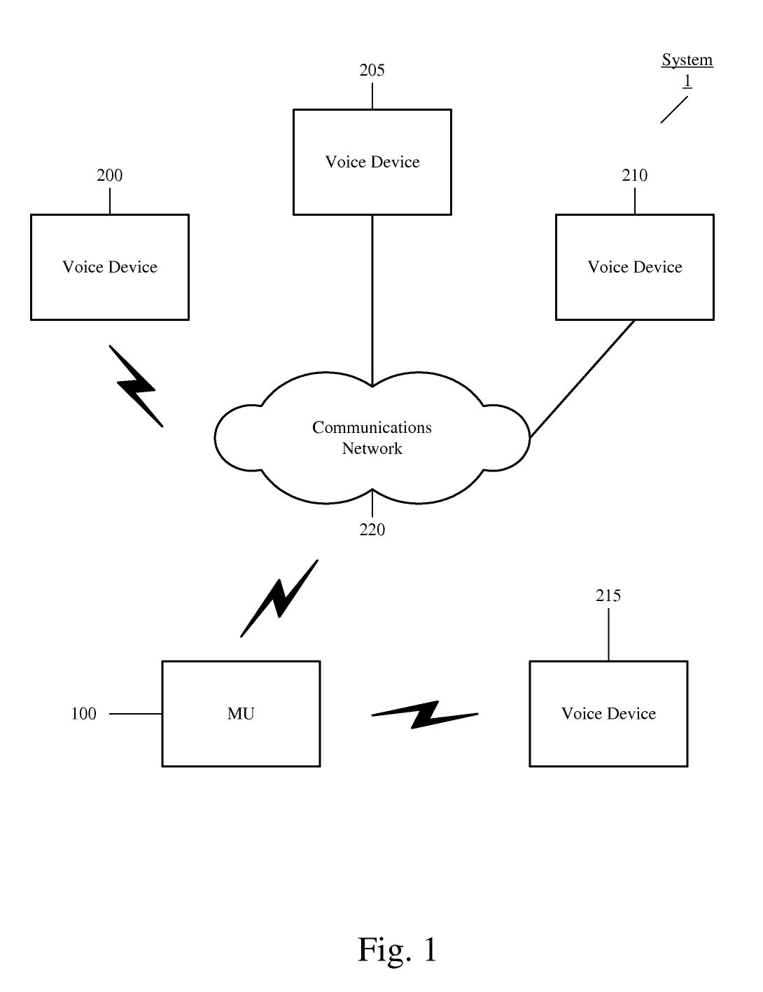

FIG. 1 shows an exemplary embodiment of a data communication system 1 for a multi-party voice call according to the present invention. The system 1 of FIG. 1 may include a plurality of devices 100, 200, 205, 210, and 215. It should be noted that that although the system has been shown to include five devices, the system may include fewer or more devices than illustrated in FIG. 1. The device 100 may be a MU that is configured to perform the multi-party call as will be described in further detail below. The devices 200, 205, 210, 215 may be electronic devices configured with a voice functionality. For example, the devices 200, 205, 210, 215 may be mobile devices and/or stationary devices such as mobile phones, PDAs, smartphones, tablets, computers, POTS phones, VOIP devices, etc. As illustrated in FIG. 1, the MU 100 may communicate with each of the voice devices 200, 205, 210, 215. The MU 100 may communicate with any of the voice devices 200, 205, 210 via the communications network 220 or with the voice device 215 via a direct connection. The device 200 may be a mobile device that is configured to communicate with the communications network 220 wirelessly while the devices 205, 210 may be stationary devices that are configured to communicate with the communications network 220 via a wired connection. In addition, the device 215 may be a mobile unit configured for a direct communications path with the MU 100 such as a half/full duplex functionality and/or other means such as IR or a tethered connection.

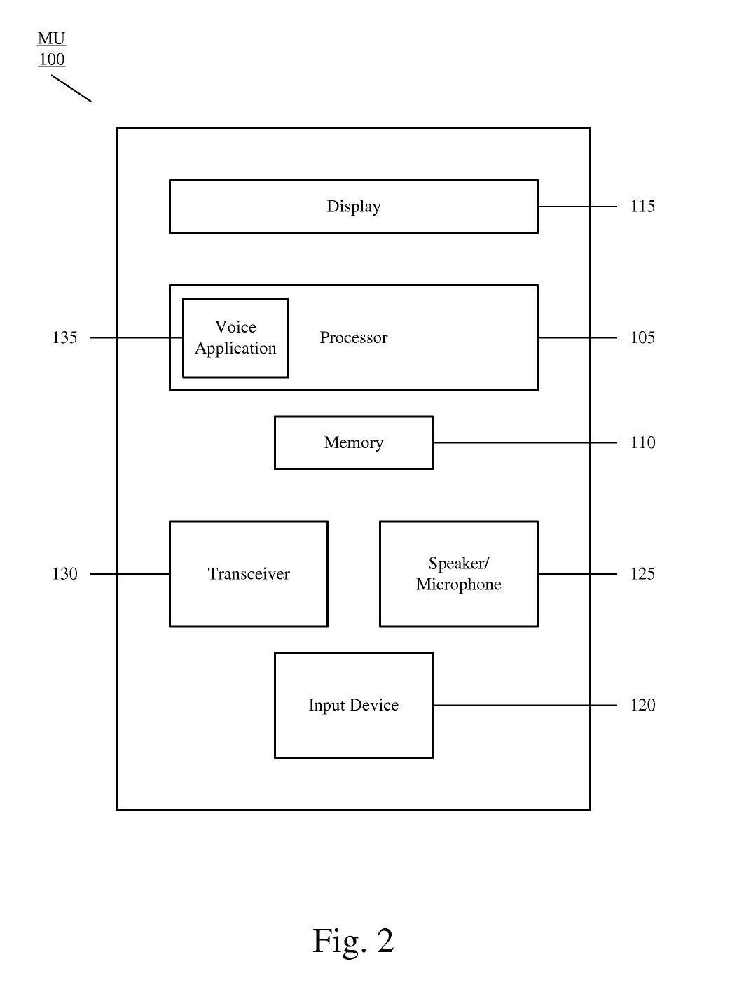

FIG. 2 shows components of the MU 100 of FIG. 1 according to an exemplary embodiment of the present invention. The MU 100 may be any electronic device that is portable and configured for a voice functionality such as a cellular phone. However, as discussed above, the MU 100 may also be configured with a video and/or data functionality as well. The components of the mobile device 100 may include a processor 105, a memory 110, a display 115, an input device 120, a speaker/microphone 125, and a transceiver 130. It should be noted that the device 100 may include a variety of other conventional components such as a power supply, ports to connect to other devices, etc.

The processor 105 may provide conventional functionalities for the mobile device 100. For example, the mobile device 100 may include a plurality of applications that are executed on the processor 105 such as an application including a web browser when connected to a network via the transceiver 130. The processor 105 of the mobile device 100 may also execute a voice application 135 to perform the multi-party call as will be described in further detail below. The memory 110 may also provide conventional functionalities for the mobile device 100. For example, the memory 110 may store data related to operations performed by the processor 105. As will be described in further detail below, the memory 110 may also store the voice application 135 including parameters such as gains for each client as well as other settings for the multi-party call.

The display 115 may be any conventional display that is configured to display data to the user. For example, the display 115 may be an LCD display, an LED display, a touch screen display, etc. The input device 120 may be any conventional input component such as a keypad, a mouse, a push-to-talk button, etc. If the display 115 is a touch screen display, allowing the user to enter information through the display 115, then the input device 120 may be optional. As will be described in further detail below, the voice application 135 may request inputs for each end point to be included in the multi-party call. The speaker/microphone 125 may be audio elements that allow voice communications from a call to be heard by the user of the MU 100 and allow audio input from the user to be converted into a voice signal to be transmitted to end points of the call.

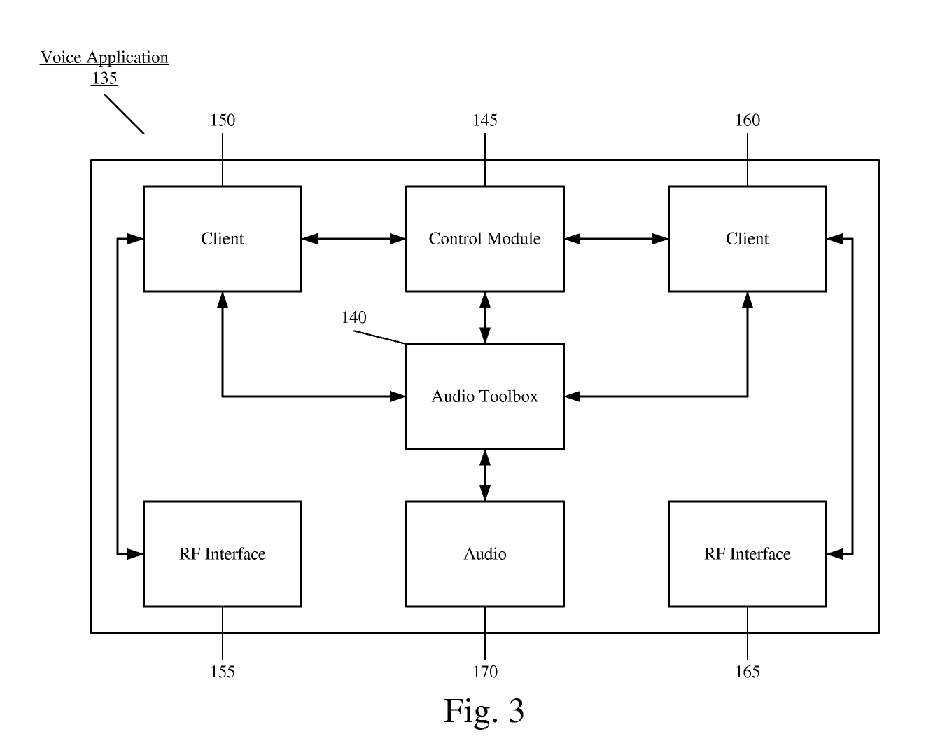

FIG. 3 shows the voice application 135 of the MU 100 for performing the multiple party voice call according to an exemplary embodiment. The voice application 135 may be a program stored in the memory 110 or alternatively on a chip to be executed on the processor 105. The voice application 135 may include an audio toolbox 140, a control module 145, a client 150 with a RF interface 155, and a client 160 with a RF interface 165. However, as will be discussed in further detail below, the number of clients and RF interfaces may be changed depending on a variety of factors.

According to the exemplary embodiments of the present invention, the voice application 135 may be configured to enable multiple end points having different interfaces to be included in a common multi-party call. The interfaces may be for the various radio frequencies used for conventional voice calls. For example, the interfaces may include GSM, 802.11, proprietary formats, etc. as well as include voice calls made using a variety of different direct connections such as full duplex and half duplex formats or indirect connections through the communication network 220 such as WAN, LAN, WLAN, LTE, WiMax, Bluetooth, Tetra, Project 25, etc. It should be noted that although the present invention is configured for all conventional interfaces, any new interface may be incorporated for the voice application 135.

Conventional conference (i.e., multi-party) calls may utilize a common interface to allow for more than one end point to be included in the call. However, the common interface is a requirement in conventional multi-party calls. Furthermore, when end points with different interfaces are to be included in a multi-party call, an intermediary device such as a private branch exchange (PBX) server is required. However, the PBX is only configured for non-mobile devices.

The voice application 135 is configured to allow the MU 100 to perform the multi-party call and include end points using different interfaces in the multi-party call, specifically via the clients 150, 160. The client 150 may be generated by the voice application 135 when the MU 100 is connected to a first end point using a first interface. The client 150 indicates the type of the first interface used and allows communication with the first end point via the RF interface 155.

If a second end point is to be included in the multi-party call, the voice application 135 may generate the client 160. If the second end point uses a second interface different than the first interface, the client 160 indicates the type of the second interface used and allows communication with the second end point via the RF interface 165.

It should be noted that the use of clients and RF interfaces may differ depending on a variety of conditions for the multi-party call. In a first example, when a third end point is to be included in the multi-party call, the voice application 135 may generate yet another client (not shown). Accordingly, if the third end point uses a third interface different than either the first or the second interface, the third client may indicate the type of the third interface used and allow communication with the third end point via a third RF interface (not shown). This process may continue for each additional end point to be included in the multi-party call.

In another example, when a common interface is utilized by more than one end point, the voice application 135 may allow for a common RF interface to be used. For example, the multi-party call may include the first, second, and third end points described above. However, in this scenario, the first and second end points use a common interface. The voice application 135 may enable the client 160 for the second end point to use the RF interface 155 in addition to the client 150 using the RF interface 155. Since the third end point uses a different interface, the third RF interface would continue to be utilized. It should be noted that the sharing of the RF interface by more than one client is only exemplary and may be an option provided by the voice application 135. According to another exemplary embodiment, the RF interface 165 may be used by the client 160 for the second end point despite sharing a common interface with another end point. Each client being supported by a respective RF interface may be generated for a variety of reasons, such as manually setting this option, determined by processing necessities, upon request from the end point, etc.

The voice application 135 may provide a variety of options regarding each end point included in the multi-party call via the audio toolbox 140 and the control module 145. A user interface may be shown on the display 115 of the MU 100 and receive inputs from the display 115/input device 120 relating to the various options for each end point. The user interface and the inputs may communicate to each client 150, 160 via the control module 145. For example, the inputs may include making a call, terminating the call, adjusting volumes for a respective client (e.g., speaker volume, microphone volume), etc. Thus, when a user enters an input to the user interface, the control module 145 may provide a response to the input for the client to which the input relates. It should be noted that a respective user interface may be provided for each client representing an end point and may further include a respective user interface for the control module 145 itself. The control module 145 further handles all user interface actions from the clients 150, 160. The control module 145 may also configure the audio toolbox 140.

The control module 145 may also allow the clients 150, 160 to interact in a vendor independent manner. As discussed above, the client 150, 160 may control the RF interface 155, 165, respectively. According to the exemplary embodiments, the control module 145 allows the clients 150, 160 to present its own view of the world to the RF interfaces 155, 165, specifically via an application programming interface (API).

According to the exemplary embodiments, since each end point is represented by a respective client, individual parameters may be set for each client via the control module 145. For example, if a call is in progress between the MU 100 and a first end point, an incoming call from a second end point may be announced on the user interface. The manner in which the announcement occurs may also be set. The routing of audio may also be predetermined. For example, each client may have a volume level set to determine how loud audio is to be played via the audio component 170. The routing of audio may be configured by the control module 145 by setting the audio toolbox 140. In another example, a parameter to be set may be controlling audio pathways between the parties involved in the multi-party call. That is, the control module 145 may have been set so that the clients 150, 160 may transmit audio from the MU 100 and the first and second end points while only the client 150 may further be set to receive audio from the first end point. That is, audio signals from the second end point may not be heard. Any combination of the audio pathways may be set in this manner. For example, the first end point may receive and/or transmit audio, the second end point may receive and/or transmit audio, any further end point may receive and/or transmit audio, and any combination thereof.

The audio toolbox 140 accepts configurations from the control module 145. The audio toolbox 140 is configured to abstract the audio layer for each client 150, 160. The audio toolbox 140 is responsible for routing packets to the client from the audio driver or other client's audio stream (and vice versa). Thus, the audio toolbox provides the functionality of mixing audio. Codecs are on a path between the client and audio toolbox. For example, the codec is in an audio driver or disposed between the client and the audio driver. Accordingly, the audio toolbox 140 is capable of interpreting (e.g., encoding and decoding) the audio to/from the client as a function of the interface run by the end point and also capable of applying gains based on the configuration. That is, the control module 145 and the audio toolbox 140 are configured to format incoming voice communications from the end points from a first interface to a second interface. For example, when a voice communication is received from the client 150 (e.g., from the first end point), the processor 105 may format the voice communication from the interface of the first end point to the interface of the second end point for a transmission. It should be noted that the voice signal from the user of the MU 100 may also be formatted in a substantially similar manner into any of the interfaces for transmission. As discussed above, each client 150, 160 may have volume parameters set and therefore, a separate gain may be applied for each stream.

According to the exemplary embodiments, the audio toolbox 140 may mix the audio by initially copying audio streams to/from the end points and the audio device driver. With multiple incoming streams at an end point, the audio toolbox 140 may sum the streams before delivering the sum to the end point. For example, when the first end point is configured to receive audio from the MU 100 and the second end point, the audio toolbox 140 adds the audio streams prior to transmitting the combined audio to the first end point. It should be noted that the gain set for the first end point (e.g., volume) is also applied prior to the combined audio being transmitted. It should also be noted that there may be intermediary steps including further conversions such as a conversion into a format that allows for the audio mixing followed by a conversion into the format of the RF interface.

It should further be noted that the audio toolbox 140 may include additional functionalities. For example, the audio toolbox 140 may include an echo cancellation functionality. The echo cancellation functionality may be conventional to remove an echo that may have been associated with an audio transmission. In yet another example, the audio toolbox 140 may include a jitter buffer functionality. The jitter buffer functionality may also be conventional so that the audio toolbox 140 is configured to queue audio transmissions into a buffer received from the plurality of end points to, for example, mix the audio prior to transmission to an end point. That is, the jitter buffer may represent any functionality to remove deviations or displacements related to audio transmissions.

According to the exemplary embodiments, the voice application 135 may add an end point to a multi-party call. The addition of the end point may include different scenarios. A call may already be in progress such as between the MU 100 and the first end point. In a first example, the second end point may be called and included in the multi-party call. In a second example, the second end point may call the MU 100 (e.g., call waiting) and subsequently included in the multi-party call.

In the first example, a call is already in progress between the MU 100 and the first end point. Thus, the client 150 already exists with the RF interface 155. If it is determined to include the second end point, the user interface of the control module 145 may first generate the client 160 with the RF interface 165 and allow a call to be initiated to the second end point. Through the user interface for the client 160, parameters may be set for the second end point. When the call is answered by the second end point, the client 160 connects the call to the multi-party call via the control module 145. Through the user interface for the client 160, adjustments to the parameters may be made for the second end point. Thus, the multi-party call includes the clients 150, 160.

It should be noted that, as discussed above, the RF interface 165 may or may not be used. For example, if the interfaces of the first and second end points are different, the RF interface 165 may be used. If the interfaces of the first and second end points are the same, the RF interface 165 may be omitted and the RF interface 155 may be used for both end points. It should also be noted that the parameters being set for the second end point prior to the call connecting thereto is only exemplary. For example, the parameters may be set subsequent to the second end point being added to the multi-party call.

In the second example, a call is again already in progress between the MU 100 and the first end point. Thus, the client 150 already exists with the RF interface 155. If the MU 100 receives a call from the second end point, a notification may be presented to the user via the user interface of the control module 145. A prompt may also be presented indicating whether the call from the second end point is to be accepted. The user interface may subsequently receive an input indicating whether the second end point is to be included in the multi-party call. If the second end point is not to be included, a conventional call waiting functionality may be performed with the first end point on hold. If the second end point is to be included, the control module 145 may first generate the client 160 with the RF interface 165. Through the user interface for the client 160, parameters may be set for the second end point. Through the user interface for the client 160, adjustments to the parameters may be made for the second end point. Thus, the multi-party call includes the clients 150, 160.

It should be noted that the above described examples may be repeated as needed and in any combination. For example, if a call is in progress between the MU 100 and the first end point, a second end point, a third end point, a fourth end point, etc. may be added using either example described above. Thus, once the multi-party call is in progress, the processor 105 with the voice application 135 including the control module 145 and the audio toolbox 140 may format the voice signals originating from end points and the user of the MU 100 accordingly for transmissions.

According to the exemplary embodiments, the voice application 135 may terminate an end point to the multi-party call. The termination of the end point may also include different scenarios. A call may already be in progress such as between the MU 100, the first end point, and the second end point. In a first example, the second end point may terminate the call. In a second example, the MU 100 may terminate the call with the second end point.

In the first example, the second end point may terminate the call (e.g., hangs up). When this occurs, the client 160 notifies the control module 145. The control module 145 may then send the configuration to the audio toolbox 140 to terminate all streams from the client 160 to other end points in the multi-party call as well as from other end points to the client 160. The user interfaces shown on the display 115 may also remove the respective one for the client 160.

In the second example, the user of the MU 100 may terminate the second end point from the multi-party call. For example, the respective user interface of the client 160 may include this option. The user interface notifies the control module 145 which notifies the client 160 to terminate the call. Subsequently, the control module 145 may perform the above described process relating to the audio toolbox 145.

It should again be noted that the above described examples may be repeated as needed and in any combination. For example, if a call is in progress between the MU 100, a first end point, a second end point, a third end point, etc., any of the end points may be terminated using either example described above.

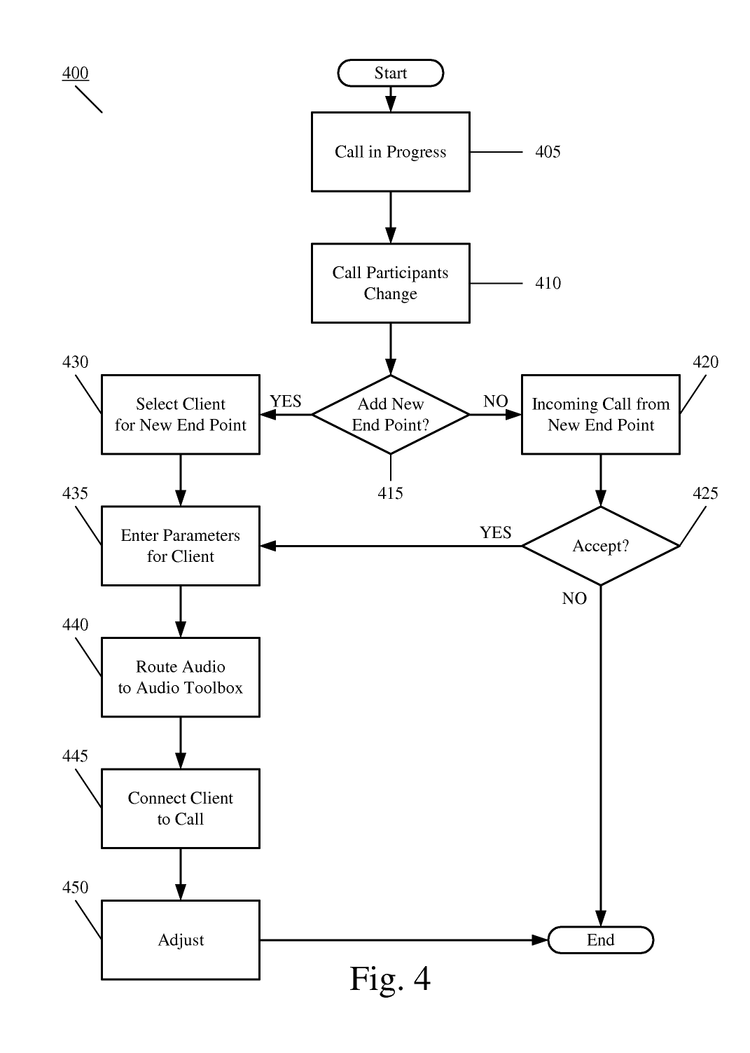

FIG. 4 shows a method 400 for adding a further end point to a multi-party voice call according to an exemplary embodiment of the present invention. The method 400 incorporates the above described examples of when the end point is added by the user of the MU 100 by initiating the call to the end point and when the end point initiates the call to the MU 100. The method 400 will be described with reference to the system of FIG. 1, the MU 100 of FIG. 2, and the voice application 135 of FIG. 3.

In step 405, a call is already in progress. Specifically, the MU 100 may already be in a call with, for example, the voice device 200. In another example, the MU 100 may already be in a call with the voice device 200 and the voice device 205, thereby already being a multi-party call.

In step 410, participants of the call already in progress undergoes a change. Specifically, the method 400 relates to the addition of a new participant. Thus, in step 415, a determination is made whether to add a new end point to the call already in progress via the MU 100. Specifically, this determination relates to when the user of the MU 100 initiates the call to the new end point. If the MU 100 is to initiate the call to the new end point, the method 400 continues to step 430 where a client is selected (e.g., generated by the voice application 135) for the new end point.

Returning to step 415, if the determination is not when the user of the MU 100 initiates the call to the new end point, then the new end point has initiated the call to the MU 100 indicated at step 420. In step 425, a determination is made whether the incoming call from the new end point is to be accepted and/or included in the multi-party call in progress. If the incoming call is accepted, a client may be selected for the new end point. As discussed above, if the incoming call is not to be included, a conventional call waiting functionality may be performed.

It should be noted that steps 410, 415, 420 relate to when the new end point uses a different interface than an end point that is already part of the call in progress. Thus, as described above, the control module 145 with the RF interfaces 155, 165 may utilize audio API's and codecs for the proper encoding and decoding of the audio signals from the different end points and their respective interfaces.

Whether the new end point has initiated the call to the MU 100 and subsequently accepted via steps 420, 425 or whether the MU 100 initiated the call to the new end point via steps 415, 430, the method 400 continues to step 435. Upon selection of a client for the new end point or inclusion of the new end point into the multi-party call in progress, in step 435, the parameters for the client of the new end point are selected. As discussed above, the parameters may relate to a variety of scenarios such as audio transmission/reception at predetermined end point, volume control, etc.

In step 440, the audio is routed to the audio toolbox 140. As discussed above, the audio may be mixed by the audio toolbox 140 as a function of the parameters selected in step 435. Subsequently, in step 445, the client for the new end point is added to the multi-party call. In step 450, the parameters for the client of the new end point as well as the clients for the other end points already involved in the multi-party call may be adjusted.

It should be noted that since further end points may subsequently be added to the call including the new end point, the method 400 may repeat as needed until all intended parties in the call have been included. Accordingly, upon the method 400 ending, the method 400 may return to step 405 where the call is in progress, except the call in progress now includes the new end point as discussed above.

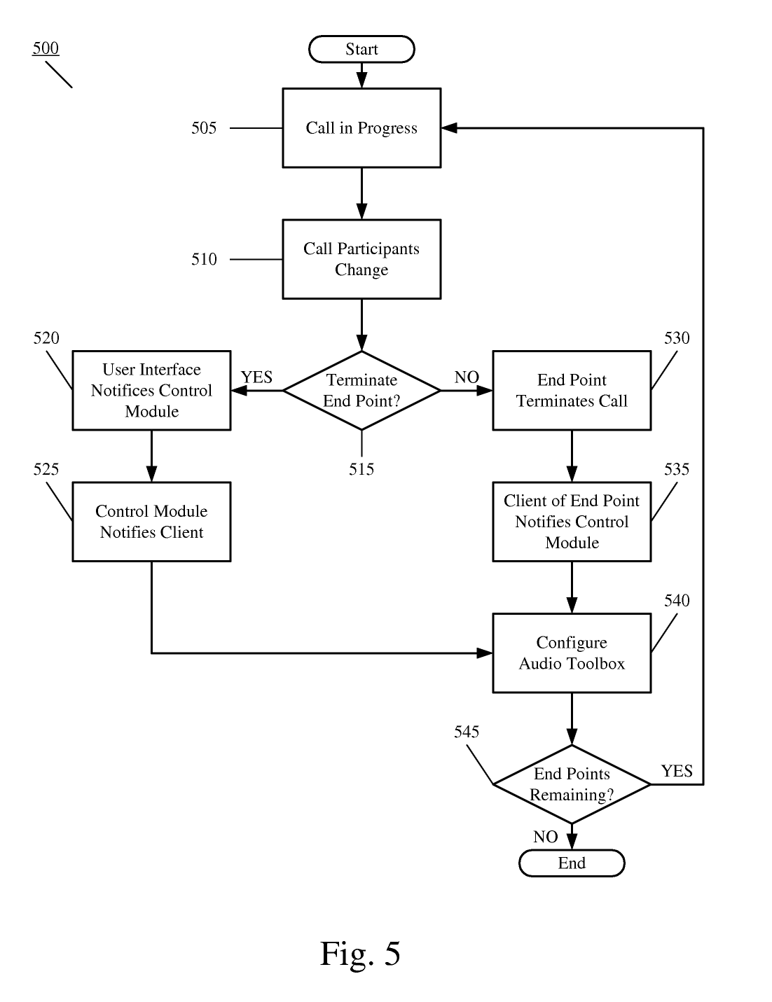

FIG. 5 shows a method 500 for terminating a further end point of a multiple party voice call according to an exemplary embodiment of the present invention. The method 500 incorporates the above described examples of when the MU 100 terminates an end point of the multi-party call or when the end point terminates the multi-party call. The method 500 will be described with reference to the system of FIG. 1, the MU 100 of FIG. 2, and the voice application 135 of FIG. 3.

In step 505, a multi-party call is already in progress. The multi-party call may be between the MU 100, the voice device 200, the voice device 205, the voice device 210, and the voice device 215. The voice devices 200, 205, 210, 215 may use different interfaces. Accordingly, the voice application 135 uses a respective client as well as a respective RF interface. However, it should be noted that if two of the voice devices use a common interface, a RF interface may be shared.

In step 510, participants of the multi-party call already in progress undergoes a change. Specifically, the method 500 relates to the termination of one of the participants. Thus, in step 515, a determination is made whether the MU 100 terminates one of the end points from the call. For example, the MU 100 may terminate the voice device 210 from the multi-party call. If this is the case, the method 500 continues to step 520 where the user interface for the client of the voice device 210 receives the input indicating that the end point is to be terminated and notifies the control module 145. In step 525, the control module 145 notifies the client of the voice device 210 that the end point is to be terminated.

Returning to step 515, the determination may indicate that the end point terminates from the call. For example, the voice device 210 may hang up and terminate its portion of the multi-party call as indicated at step 530. If this is the case, the method 500 continues to step 535 where the client for the voice device 210 notifies the control module 145.

Whether the MU 100 terminates the device 210 from the call via steps 520, 525 or if the device 210 terminates from the call via steps 530, 535, once the client and control module are aware that the end point is to be terminated, the method 500 continues to step 540. In step 540, the audio toolbox 140 is configured to incorporate the termination of the end point. As discussed above, the control module 145 may send the configuration to the audio toolbox 140 to terminate all streams from the client 160 to other end points in the multi-party call as well as from other end points to the client 160. The user interfaces shown on the display 115 may also remove the respective one for the client 160.

In step 545, a determination is made whether any end points remain in the call. If there is at least one end point remaining, the method 500 returns to step 505 where the call is in progress, except the call no longer includes the device 210. Once no more end points are in the call, the method 500 ends.

The exemplary embodiments enable a multi-party call with more than one end point where the end points may use different interfaces. Specifically, a mobile unit may be configured with a voice application to perform the multi-party call with this feature. To accommodate the different forms of interfaces, the voice application may include a control module and an audio toolbox. The control module may configure the audio toolbox which mixes audio as a function of parameters set for each end point of the multi-party call. The audio toolbox may incorporate API's with audio drivers and codecs for each type of interface. The voice application may also include a respective client for each end point of the multi-party call. A RF interface may be associated with each client or may be associated with each type of interface for the end points of the multi-party call.

Those skilled in the art will understand that the above described exemplary embodiments may be implemented in any number of manners, including, as a separate software module, as a combination of hardware and software, etc. For example, the voice application 135 of the mobile device 100 may be a program containing lines of code that, when compiled, may be executed on the processor 105.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A mobile device, comprising:
a transceiver configured to receive first wireless voice communications from a first end point in a first format; and
a processor configured to reformat the first wireless voice communications from the first format to a second format, wherein the second format is an operating format of a second end point and wherein the transceiver transmits the reformatted first wireless voice communications to the second end point.

2. The mobile device of claim 1, further comprising:
an audio element configured to receive an audio input from a user of the mobile device and generates a voice signal from the audio input, wherein the processor formats the voice signal into the second format and wherein the transceiver transmits the voice signal in the second format to the second end point.

3. The mobile device of claim 1, wherein transceiver is further configured to receive second wireless voice communications from the second end point in the second format and the processor reformats the second voice communications from the second format to the first format, wherein the transceiver transmits the reformatted second wireless voice communications to the first end point.

4. The mobile device of claim 2, wherein the processor formats the voice signal into the first format and wherein the transceiver transmits the voice signal in the first format to the first end point.

5. The mobile device of claim 2, wherein the processor initially stores and mixes the first wireless voice communications and the voice signals, the processor subsequently converting the mixed signal into the second format for transmission to the second end point.

6. The mobile device of claim 3, further comprising:
a memory storing a voice application, the processor being configured to execute the voice application, the voice application including a first client for the first end point and a second client for the second end point.

7. The mobile device of claim 6, wherein the first client includes a first interface for the first format and the second client includes a second interface for the second format.

8. The mobile device of claim 6, wherein the voice application includes at least one of an application programming interface, a codec, and an audio driver for the formatting.

9. The mobile device of claim 6, wherein the voice application includes a control module that configures parameters and performs functionalities for each of the end points.

10. The mobile device of claim 9, wherein the parameters related to each of the first and second end points, the parameters including a gain level, an activation of at least one of audio transmission and reception, and a deactivation of at least one of the audio transmission and reception and wherein the functionalities including making, performing, and terminating a call.

11. A method, comprising:
receiving first wireless voice communications by a transceiver of a mobile device from a first end point in a first format;
reformatting, by a processor of the mobile device, the first wireless voice communications from the first format to a second format, the second format being an operating format of a second end point; and
transmitting, by the transceiver of the mobile device, the reformatted first wireless voice communications to the second end point.

12. The method of claim 11, further comprising:
receiving, by an audio element of the mobile device, an audio input from a user of the mobile device;
generating, by the processor of the mobile device, a voice signal from the audio input;
formatting, by the processor of the mobile device, the voice signal into the second format; and
transmitting, by the transceiver of the mobile device, the voice signal in the second format to the second end point.

13. The method of claim 11, further comprising:
receiving, by the transceiver of the mobile device, second wireless voice communications from the second end point in the second format;
formatting, by the processor of the mobile device, the second voice communications from the second format to the first format; and
transmitting, by the transceiver of the mobile device, the reformatted second wireless voice communications to the first end point.

14. The method of claim 12, further comprising:
formatting, by the processor of the mobile device, the voice signal into the first format; and
transmitting, by the transceiver of the mobile device, the voice signal in the first format to the first end point.

15. The method of claim 12, further comprising:
storing, in a memory of the mobile device, the first wireless voice communications and the voice signals;
mixing, by the processor of the mobile device, the first wireless voice communications and the voice signals;
converting the mixed signal into the second format for transmission to the second end point.

16. The method of claim 13, wherein the processor executes a voice application including a first client for the first end point and a second client for the second end point.

17. The method of claim 16, wherein the first client includes a first interface for the first format and the second client includes a second interface for the second format.

18. The method of claim 16, wherein the voice application includes at least one of an application programming interface, a codec, and an audio driver for the formatting.

19. The method of claim 16, wherein the voice application includes a control module that configures parameters and performs functionalities for each of the end points.

20. A computer readable storage medium including a set of instructions executable by a processor, the set of instructions operable to:
receive first wireless voice communications by a transceiver of a mobile device from a first end point in a first format;
reformat the first wireless voice communications from the first format to a second format, the second format being an operating format of a second end point; and
transmit the reformatted first wireless voice communications to the second end point.
